(19) United States
(12) Patent Application Publication
(10) Pub. No.: US 2003/0005048 A1
(43) Pub. Date: Jan. 2, 2003

(54) System and method for integrated web-based software code environment

(75) Inventor: Vincent Risalvato, Tampa, FL (US)

Correspondence Address: Alan M. Weisberg, Christopher & Weisberg, P.A., Suite 2040, 200 East Las Olas Boulevard, Fort Lauderdale, FL, 33301, US

(73) Assignee: Rivar Technologies, Inc.

(21) Appl. No.: 10/170,931

(22) Filed: Jun. 13, 2002

Related U.S. Application Data
(60) Provisional application No. 60/297,446, filed on Jun. 13, 2001.

(51) Int. Cl. G06F 15/16

(52) U.S. Cl. 709/203

(57) ABSTRACT

A method and system for a web-based application in which integrated source code is prepared. The integrated source code includes source code in a first programming language and source code in a second programming language. The integrated source code is processed to create compilable homogenous source code in the first programming language. The homogeneous source code is compiled into a natively executable web-based program.

### CROSS-REFERENCE TO RELATED APPLICATION

This application is related to and claims priority to U.S. Provisional Application Serial No. 60/297,446, filed Jun. 13, 2001, entitled CODE NEO, the entirety of which is incorporated herein by reference.

### STATEMENT REGARDING FEDERALLY SPONSORED RESEARCH OR DEVELOPMENT

n/a

### FIELD OF THE INVENTION

The present invention relates to a system and method for providing web-based applications using integrated software, and in particular, to a system and method for the development and serving of web-based applications using a processing software language such as C++ in combination with a traditional web coding language such as the hypertext mark-up language (“HTML”).

### BACKGROUND OF THE INVENTION

As the proliferation of network-based computing increases, so to does the need for the increasingly sophisticated network-based applications and services. Whether on an intranet or the Internet, users of client computing devices typically access applications using a web browser such as MICROSOFT's INTERNET EXPLORER, NETSCAPE's NAVIGATOR, and the like. These browsers are typically arranged to receive data from a web server using a standard protocol such as the Transmission Control Protocol/Internet Protocol (“TCP/IP”). Contemporary web programming languages like Java, Java Server Page (“JSP”), Active Server Page (“ASP”) and Cold Fusion run slower on a given processor as compared with traditional object oriented languages such as C++. For example, Java requires a virtual machine to execute Java applications; JSP must be converted into a Java servelet which is then executed within the Java virtual machine; ASP requires an interpreter to execute each instruction, one at a time; and Cold Fusion requires a software system to parse the Cold Fusion tags and link them to functionality within their application server.

Typically, web servers are designed to support a set number of simultaneous users. Exceeding that number results in the prevention of users from accessing all or a portion of a web site. This occurs, for example, when many users to attempt to access a web site to buy just-released concert tickets. As more customers attempt to access data-rich, dynamic content sites, such as to order products, fill out a form, or query a database, the potential for bottlenecks increases. To minimize these bottlenecks, businesses typically expand their networking infrastructure by adding expensive additional hardware, typically in the form of servers, to overcome these performance problems.

It is therefore advantageous to have a programming language which results in executable code that runs faster than contemporary web programming languages. As a result of their inefficiency, contemporary web programming languages require higher speed processors and additional memory as compared with the execution of traditional object-oriented programming languages. In other words, it is desirable to have an application development environment which allows the compilation of the code into a highly optimized native binary code which requires no interpretation or software abstraction layer to be executed.

Further, businesses are moving non-commerce-related software programs for sales force automation, customer relationship management and the like to the Internet. Because many existing backend software applications are written in traditional programming languages such as C and C++, they are incompatible with contemporary web application platforms. As such, it takes a vast amount of time and money to rewrite these applications for the Internet as “web enabling”. These applications often include porting the entire code base from the traditional programming language to the contemporary web application platform. It is therefore desirable to have a web application development and server environment which does not require software applications written in traditional programming languages such as C and C++ to be rewritten using a contemporary web application language.

Contemporary web application environments such as those which use Java, ASP and Cold Fusion are arranged such that the source code is left in a state which can be easily acquired. This is the case because these application environments require that the source code be stored on the web server which is accessed by the browser enabled client computer or because the web server must read and execute one source code instruction at a time based on a request for data received from the client computing device. The result is that software component developers who create programs for the web risk intellectual property theft, because they can not secure their products from reverse engineering when these products are deployed. It is therefore also desirable to have a web-based computing environment which allows software component developers to release development libraries without being afraid of giving away trade secrets due to unauthorized access or authorized access coupled with subsequent unauthorized use of the acquired source code.

As the choices for web-based software developers increase with respect to the available development environments, so too does developers' frustrations. Typically, a new web-based development application requires the software developer to learn to navigate within yet another development environment using new development tools, methodologies, etc. It is therefore also desirable to provide a development environment in which developers can continue to use the tools that they prefer to use by allowing easy integration with existing tools. Further, rather than provide yet another programming language, it is desirable to provide a development environment in which existing Java, PERL, or ASP programs can be enhanced to execute faster than these contemporary languages can execute on their own on a web server.

### SUMMARY OF THE INVENTION

The present invention advantageously provides a method and system for providing web-based application programs.

According to an aspect, the present invention provides a method for a web-based application in which integrated source code is prepared. The integrated source code includes source code in a first programming language and source code in a second programming language. The integrated source code is processed to create compilable homogenous source code in the first programming language.

In accordance with another aspect, the first programming language is C++.

In accordance with still another aspect, the present invention provides a system for providing web data to a web client which the system includes a development server. The development server has a memory and a central processing unit operably coupled to the memory. The memory stores integrated source code. The integrated source code includes source code in a first programming language and source code in a second programming language. The central processing unit processes the integrated source code to create compilable homogenous source code in the first programming language.

In accordance with yet another aspect, the present invention provides computing device for developing a web application, in which the computing device has a memory and a central processing unit operatively coupled to the memory. The memory stores a first source code for a program, the first source code for the program is written in a plurality of programming languages. The central processing unit processes the first source code to create a second source code corresponding to the source code. The second source code is in one of the plurality of programming languages.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the invention;

FIG. 2 is a flowchart of the overall process of the present invention;

FIG. 3 is a flowchart of the process of creating a source joint from a rivet;

FIG. 4 is a flowchart of the compilation process of the present invention;

FIG. 5 is a flowchart of the application server execution process; and

FIG. 6 is a flowchart showing the rivet creation and compilation process in a development environment such as MICROSOFT's FRONT PAGE Environment.

### DETAILED DESCRIPTION OF THE INVENTION

Initially, it is noted that as used herein, the term “traditional programming language” refers to programming languages not specifically designed for web-based implementation such as C and C++. As used herein, the term “contemporary web programming language” or “contemporary web-based programming language” refers to programming languages and environments specifically intended for web implementation such as Java, Cold Fusion, ASP and the like.

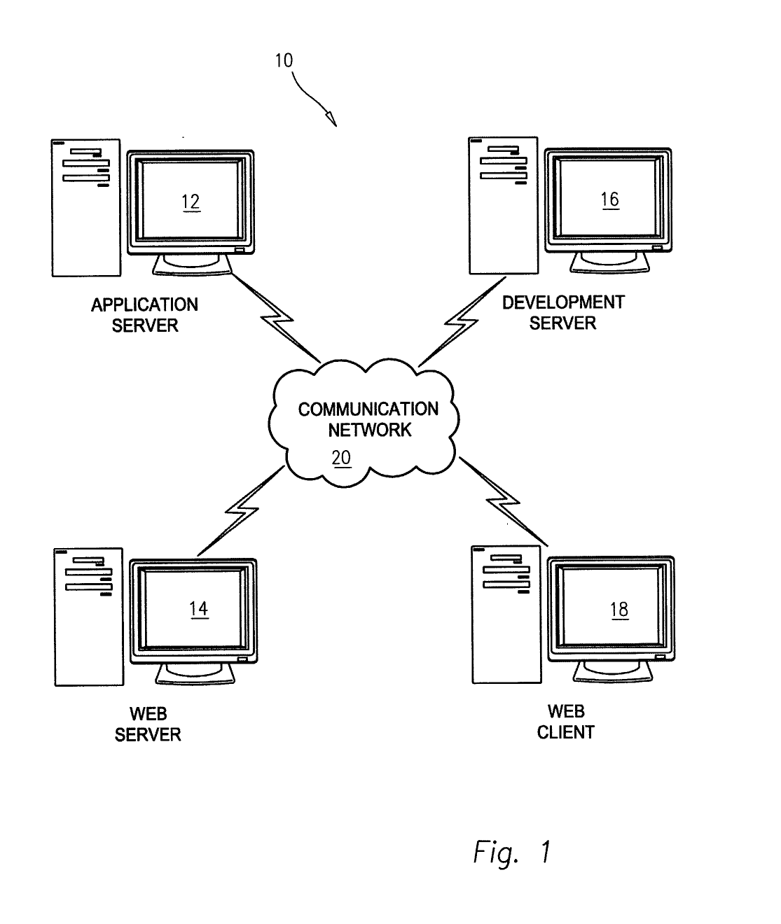

Referring now to the drawing Figures in which like reference designators refer to like elements, there is shown in FIG. 1 a system constructed in accordance with the principles of the present invention and designated generally as 10. System 10 includes an application server 12, web server 14, development server 16 and web client 18 coupled to communication network 20 through communication links 22. Although a single application server 12, web server 14, development server 16 and web client 18 are shown in FIG. 1, it is understood that a plurality of one or more of these devices can be implemented in accordance with the present invention.

Further, although each of application server 12, web server 14, development server 16 and web client 18 are shown coupled to communication network 20, it is also understood that one or more of these devices can be coupled directly together through a data communication link such as a serial data connection, local area network connection and the like. Also, although application server 12, web server 14 and development server 16 are shown as separate devices, it is further understood that the below-described functions and programs for the application server, web server and development server can be implemented on fewer than three discrete computing platforms.

Application server 12 can be any computing platform suitable for implementing network-based application service functions. For example, application server 12 is preferably arranged to include suitable random access memory, non-volatile storage devices, network interface hardware and central processing unit suitable to perform application service functions via communication network 20. For example, an application server 12 intended to support a few simultaneous users is likely to be configured by one or ordinary skill in the art to have a smaller capacity central processing unit, less random access memory (“RAM”) and smaller non-volatile storage capacity than an application server intended to support a large number of users and/or a large database.

The application server 12 runs an application server program which provides the logic for an application program, such as DSO executable files under UNIX or DLL executable files in the MICROSOFT operating environment. The application server program interoperates with a web server program executed by web server 14, discussed below in detail. The web server 12 executes a web server program that uses a suitable communication protocol such as the hypertext transfer protocol (“HTTP”) to serve the files that form web pages to web client 18. Exemplary web server programs are MICROSOFT's INTERNET INFORMATION SERVER (“IIS”) and APACHE

In operation, the web server program forwards requests received from web client 18 to application server 12 such that the application server program executing on application server 12 provides appropriate data back to the web server 14 so that web server 14 can forward the modified or new web page to the web client 18.

Like application server 12, web server 14 includes substantially the same components as those discussed above with respect to application server 12 such that the components are sized to provide capacities and capabilities suitable for the expected demands to be placed thereon. Development server 16 is arranged to include substantially similar components to those discussed above with respect to application server 12, with the capacities of the components of development server 16 sized to accommodate the expected demands placed thereon. As discussed below in detail, development server 16 is accessed by software developers to aid their development efforts for the creation of integrated code, the compilation of integrated code into executable format, the placement of the executable files on application server 12 along with the updating of these executable files as may be necessary from time to time.

Application server 12, web server 14 and development server 16 can vary in size and capacity from a small personal computer to a large multi-processor mainframe computer, depending on the expected operating environment.

Web client 18 is any computing device capable of running web browser software and having a communications network connection. For example, web client 18 can be a personal digital assistant (“PDA”), personal computer, workstation, handheld computer and the like equipped with a web browser such as MICROSOFT's INTERNET EXPLORER or NETSCAPE's NAVIGATOR. Web client 18 also includes the network interface hardware required to allow web client 18 to communicate using communication network 20 via link 22.

Links 22 can take the form of any suitable data communication link, such as serial connections, wide area network links, local area network links, frame relay links, asynchronous transfer mode (“ATM”) links, fiber optic links, wireless communication links, and the like in any desired combination.

In operation, a user of web-client 18 inputs the desired address, typically in a uniform resource locator (“URL”) format for a desired website. Through the communication network communication software stack on web client 18, the web browser causes a request for web site information to be transmitted to web server 14 via communication network 20. Web server 14 initializes the appropriate application from application server 12 and formats and transmits a response back to web client 18, typically in HTML format, so that the web browser executing on web client 18 can format the requested information into a form observable by the user on the web client.

As is discussed below in detail, the present invention advantageously provides a method and system by which application server 12 executes binary modules in order to quickly provide data to web server 14 to serve web pages to web client 18. The binary modules have been found to execute an order of magnitude faster on a given computing platform than when contemporary web-based solutions are executed on application server 12. In order to accomplish this performance increase, the present invention advantageously allows developers to insert code written in traditional programming language such as C or C++ directly in the web page source by using their preferred development environment, such as text editor, CODE:NEO web development environment, MICROSOFT FRONT PAGE and the like.

The present invention also advantageously allows the reuse of existing programmatic software code bases such as those which may have been previously been written in a traditional computer language. A result is that the present invention advantageously decreases development time for new web-based applications by reusing existing programs written in traditional programming languages. The increased performance of the subject invention allows more users per web server 14, thereby decreasing ownership costs for implementing entities.

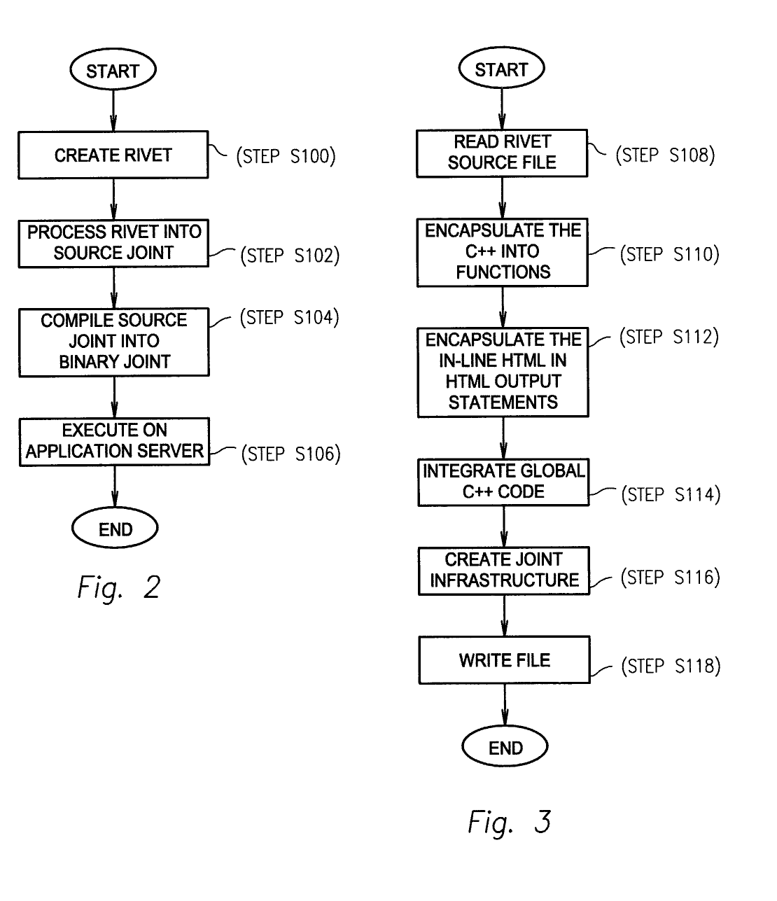

The process of the present invention is described with reference to FIG. 2. Initially, a developer, such as a web site developer creates a source code rivet (Step S100). A source code rivet is a text file which contains native web site source code such as HTML and traditional source code such as C++ source code delineated by custom tags which document where the HTML and C++ start and stop. An exemplary tag list is shown with its accompanying descriptions in Table 1.

TABLE 1

| TAG | DESCRIPTION |
|---|---|
| <%Cn> | Begin a C++ inline block |
| </Cn%> | End any C++ code block |
| <%Cn scope=“global”> | Begin a C++ global code block |

The created integrated source code rivet is processed into a source joint (Step S102). A source joint is a file purely in the traditional software language, such as C++, which conforms to a specification that can be compiled using a compiler for the traditional language to produce a “binary joint” which can be executed by application server 12. The source joint is therefore homogeneous source code. The source joint is compiled into a binary joint (Step S104). A binary joint is the binary code that can be natively executed by application server 12. For example, a binary joint can be a dynamic shared object (“DSO”) under the Unix operating system or a dynamic link library (“DLL”) under the WINDOWS operating system.

When called by web server 14, the binary joint is executed by application server 12 with the results provided to web server 14 for inclusion in the web page data provided to web client 18. Web client 18 receives the resultant web page data, for example in HTML form, and formats the HTML code into the corresponding web page for display to the user of web client 18 (not shown).

Each of Steps S100-S106 are now discussed in detail. Referring to Step S100 in FIG. 2, the first step in creating an application using the present invention is creating the source files that will be used to create a binary executable that can be executed by application server 12. Any traditional method of creating text source files can be used to create a source code rivet. For example, a developer can use a web development environment (“WDE”) which provides an online web-based mechanism for development. The WDE, the WDE allows the developer to create source code rivets as well as maintain the configuration of application server 12 and web server 14. The WDE can be provided, for example, on development server 16.

Also in accordance with the present invention, the developer can develop the source code rivet on their local machine and publish the pages using a known development tool such as MICROSOFT's FRONT PAGE. This arrangement is discussed below in detail. Using this arrangement, development server 16 “catches” the FRONT PAGE publishing mechanism and triggers the generation and compilation of the source code rivet into a binary joint. Other mechanisms contemplated for use in creating the source code rivet are to create the source code rivet on the developer's local computing platform and then transfer the source code rivet using a suitable file transfer mechanism such as the file transfer protocol (“FTP”). In the alternative, users may “log on” to development server 16 and create source code rivets directly on development server 16 such as by using WINDOWS TERMINAL SERVER, telenet, and the like.

An example of a source code rivet is as follows: <html><body>hello world</body></html>. This simple example is a valid source code rivet. While this example does not have any C++ code or functionality, it is still convertible into a source joint and binary joint which is executable by application server 12. The resultant output would simply be the same as the example. A more complex example is as follows:

<html><body>Count to ten<br><%Cn>

for(int x=1;x<=10;x++)swritef(“%d<br>”,x);

</Cn%></body></html>.

After conversion into a source joint and subsequent compilation into a binary joint, the output would be “count to ten”, then the number 1-10, each appearing on its own line. As shown in this example, the C++ and HTML is separated by the integrated code tags shown in Table 1. For example, the “<%Cn>” tag demarks the beginning of the C++ source code and is referred to as the integrated code opening tag. The “</Cn%>” tag demarks the end of the C++ source code and is referred to as the integrated code close tag. Additionally, the opening tag can specify the type of language to follow, such as “<%Cn lang=“C++”>”.

Tags implemented in accordance with the present invention preferably have one of two scopes, global and in-line. By default, scope is established as in-line, but can be changed to global by specifying it as “<%Cn scope=“global”>”. Global sections can be closed with the integrated close tag. The scope controls how the development tool on development server 16 places code in the resultant source joint file processed in accordance with Step S102. Code blocks which are in-line are placed in the order that they are found in the source code rivet file. Code blocks which are global are placed in the order they are found in the beginning of the source joint in the C++ global space. An example of a source code rivet which implements the “global” tag is as follows:

<%Cn scope=“global”>int x;</Cn%>

<html><body>Count to ten<br><%Cn>

for(x=1;x<=10;x++)swritef(“%d<br>”,x);

</Cn%></body></html>.

In accordance with the present invention, traditional source code such as C++ code, is easily integrated with HTML code. This arrangement allows a developer to reuse existing traditional language source code to create the desired web application.

The processing of a source code rivet into a source joint in accordance with Step S102 is described. If the developer has developed a source code rivet, the source code rivet needs to be converted into a source joint before it can be compiled into a binary joint. This process is preferably performed by development server 16. In a case where source code rivets are created on a computing platform other than development server 16, such as the developer's personal computing device, the source code rivet is transferred to development server 16. In the case where a WDE is used or where the source code rivet is created directly on development server 16, no such transfer is required.

The processing of the source code rivet into the source joint by development server 16 is described with reference to FIG. 3. Initially, the integrated code development application reads the source code rivet file (Step S108). The C++ source code is encapsulated into functions (Step S110). The in-line HTML is encapsulated in HTML output statements (Step S112). C++ source code tagged as global, C++ code is integrated (Step S114), the joint infrastructure is created (Step S116) and the resultant source joint is written into a file and saved by development server 16 (Step S118).

It is presumed that one of ordinary skill in the art of writing software development tools can prepare the above-described integrated code development application based on the descriptions herein.

An example of processing a source code rivet into a source joint using the integrated code development application is as follows. The source code rivet:

<html><body>Count to ten<br><%Cn>

for(int x=1;x<=10;x++)swritef(“%d<br>”,x);

</Cn%></body></html>

is processed into the following source joint by the integrated code development application:

#include <CnJoint.h>

#include <CnHtmlServer.h>

using namespace CodeNeo;

class CnJoint : public CodeNeo::CnHtmlServer

{

public:

CnJoint(CodeNeo::CnRequest *pCnRequest):

CodeNeo::CnHtmlServer(pCnRequest) { }

void main( );

private:

};

CNJOINT_ENTRYPOINT(CnJoint)

void CnJoint::main( )

{

swrite(“<html><body>Count to ten<br>”);

for(int

x=1;x<=10;x++)swritef(“%d<br>”,x);swrite(“</body></h

tml>\n”);

}

As shown in this example, the term “Code Neo” corresponds to the name of a system constructed in accordance with the principles of the present invention and made available by Rivar Technologies, Inc.

As still a more complex example, the source code rivet:

<%Cn scope=“global”>int x;</Cn%>

<html><body>Count to ten<br><%Cn>

for(x=1;x<=10;x++){

swritef(“%d<br>”,x);

if(x==5)

</Cn%>We are half way to

ten<br><%Cn>

}

</Cn n%></body></html>

is processed into the following source joint by the integrated code development application executing on development server 16:

#include <CnJoint.h>

#include <CnHtmlServer.h>

using namespace CodeNeo;

int x;

class CnJoint : public CodeNeo::CnHtmlServer

{

public:

CnJoint(CodeNeo::CnRequest *pCnRequest)

CodeNeo::CnHtmlServer(pCnRequest) { }

void main( );

private:

};

CNJOINT_ENTRYPOINT(CnJoint)

void CnJoint::main( )

{

swrite(“\n”);

swrite(“<html><body>Count to ten<br>”);

for(x=1;x<=10;x++){

swritef(“%d<br>”,x);

if(x==5)

swrite(“We are half way to ten<br>”);

}

swrite(“</body></html>”);

}

In the above example the “# include” s, such as “# include <CnJoint.h>” include infrastructure which defines the resources the joint has available. The source joint examples declare that the corresponding source joint will use the name space CodeNeo which the integrated code environment application programming interface (“API”) is coded to be present in. These source joint files define an object which extends “CnHtmlServer” which is the base class for HTML joints. A macro hooks the newly defined joint to an entry point that application server 12 can call. A main function that will be called after the object is created and prepared by application server 12 is implemented.

The source joint file is preferably assigned a predetermined file extension. Although any extension can be used, the description of the present invention herein describes the source code file as having a “.CnSrc” extension.

Although the present invention is described in FIG. 2 as including a source code rivet creation step (Step S100) and the processing of that source code rivet into a source joint (Step S102), it is contemplated that a developer proficient with the present invention may elect to directly create or use a source joint. Because the source joint is source code in the traditional programming language, such as C++, it is not necessary that the integrated source code rivet first be created and processed into the source joint by development server 16. In other words, instead of creating a file which contains C++ and HTML, the developer may create a pure C++ source file which conforms to the above-described joint specifications.

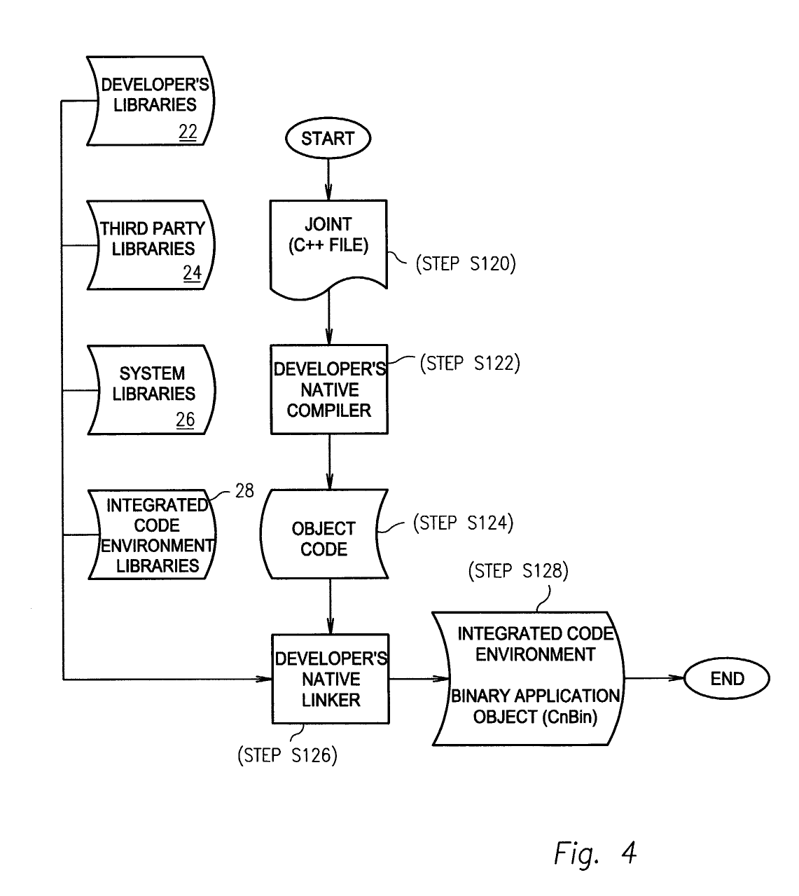

The compilation of a source joint into a binary joint as set forth in Step S104 is described with reference to FIG. 4. FIG. 4 is a flowchart of the compilation process of the present invention. Initially, the source joint such as the C++ source joint file having the .CnSrc file extension is loaded into the corresponding developer's native compiler (Step S120).

The source joint is then compiled using the developer's native compiler (Step 122). Of note, an advantage with the present invention over previous systems is that the present invention allows the developer to continue to use his or her own preferred native compiler, for example, the developer's native C++ compiler.

The resultant output of the native compiler is the creation of object code (Step S124). Examples of compilers suitable for use with C++ code include MICROSOFT's VISUAL C++, GNU GCC, and the like. The developer's native linker uses the object code created in Steps S122 and S124 to link the object code with various libraries such as the developer's own libraries 22, third party libraries 24, system libraries 26, and libraries associated with the integrated code environment such as integrated code environment libraries 28. For example, integrated code environment libraries 28 might contain the header files discussed above with respect to the “#include” files (Step S126).

The resultant binary joint is output as an integrated code environment binary application object (Step S128). The binary joint can use any suitable file extension, for example “.CnBin”. The resultant binary joint created on development server 16 is transferred to application server 12. The transfer can be manual, such as by FTP, downloaded to a floppy disk or CD-ROM and physically taken to and installed on application server 12 or can be automatically initiated as part of the compilation process of Step S104. The web server program, through its extension application program interface (“API”), has an association between files with extensions of the integrated code environment binary application object, for example, “.CnBin” with the application server of the present invention. When the web server receives one of these requests, it passes control of execution to application server 12.

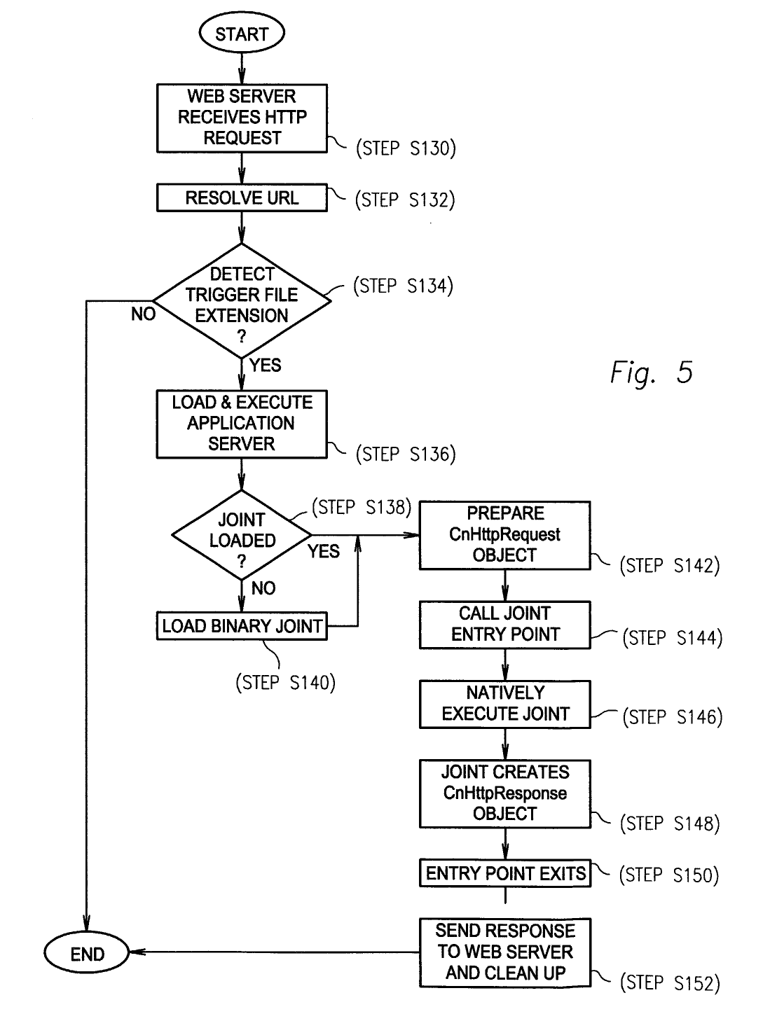

The execution of the binary joint, i.e. integrated code environment binary application object, by application server 12 as set forth in set Step S106 in FIG. 2 is described with reference to FIG. 5. In operation, web server 14 receives an HTTP request from web client 18 (Step S130). The web server program executing in web server 14 resolves the URL received as part of the HTTP request to determine the requested web page/file (Step S132). The web server program then evaluates the file to determine whether the extension corresponding to the requested file corresponds to a binary joint, i.e. is an integrated code environment binary application object having, for example, a .CnBin extension (Step S134). If the file extension does not correspond to an integrated code environment binary application object, the process of the present invention ends. However, if the integrated code environment binary application object file extension is detected, the application server program is loaded and executed if it is not already loaded and executed, on application server 12 (Step S136). When the application server program begins, it determines whether the corresponding binary joint has been loaded and cached (Step S138). If the binary joint has not been loaded, it loads the binary joint into memory (Step S140), for example using the DSO or DLL load function of the corresponding operating system.

The application server program on application server 12 also prepares an object named CnHttpRequest (Step S142). This object encapsulates all of the specific information about the web request received from web client 18. The entry point of the binary joint is called, passing a pointer to the CnHttpRequest (Step S142) object so that binary joint can determine which request it should be processing (Step S144). The binary joint is natively executed by application server 12 (Step S146). The results of the processing is such that the executed binary joint creates a response object, named for example CnHttpResponse (Step S148). The entry point of the executed joint exits (Step S150). The response object is sent to web server 14 and the application server program “cleans up”, i.e. resets variables, pointers, etc. (Step S152). The response object contains the data, i.e. payload which is provided to web server 14 for transmission to the requesting web client 18.

Because the binary joint is natively executed in Step S146, the execution speed and resources consumed by application server 12 is much faster, for example an order of magnitude faster, than applications written in contemporary web-based languages such as JSP, ASP, Cold Fusion, and the like. Further, because the integrated code environment binary application object is stored in its natively executable form on application server 12, with only the results being provided to web server 14, the present invention inherently adds a level of security not found in known web environments.

As a result of the speed increases and added security, performance for demanding applications such as transaction processing, interactive form generation, security and authentication procedures, access to complex databases and the like are supported with improved performance over known systems.

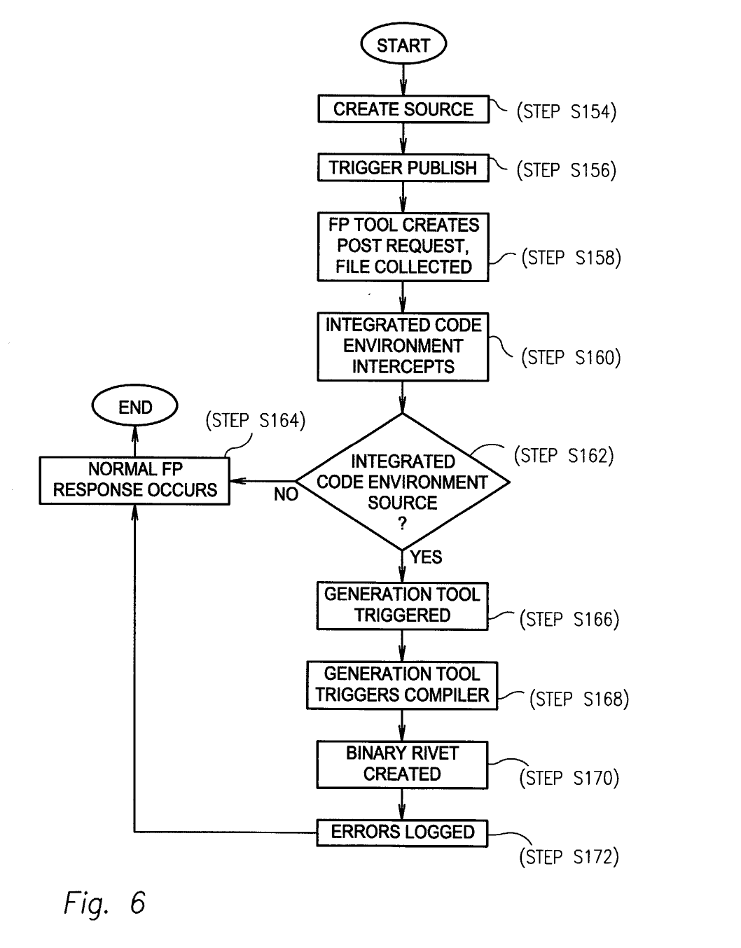

In describing Step S100 above with respect to source code rivet creation, it was noted that web publishing or development environments such as MICROSOFT's FRONT PAGE and MACROMEDIA's DREAMWEAVER are easily integrated with the present invention to provide a developer with an efficient way to create binary joints. An example of a development environment using an environment similar to MICROSOFT's FRONT PAGE is described with reference to FIG. 6. The developer creates the source rivet using the environment (Step S154). Once the source with the integrated source code, for example HTML and C++, is created, the developer triggers the environment to “publish” the source code rivet (Step S156). The environment, such as the FRONT PAGE tool, creates a post request and collects the source code file (Step S158).

An API associated with the integrated code environment of the present invention intercepts the file collection (Step S160) and determines whether the created source code is that described above, namely includes tags identifying embedded code as traditional language source code (Step S162). In other words, development server 16 determines whether the resultant source code is a source code rivet.

If the source code is not integrated source code i.e., is not a source code rivet, the normal FRONT PAGE response occurs (Step S164). If the source code is a source code rivet, the generation tool described above on development server 16 with respect to Step S102 in FIG. 2 is triggered (Step S166), a source joint is created and the compilation process described above with respect to Step S104 in FIG. 2 (Step S168) is triggered. The result is the creation of a binary rivet, i.e. an integrated code environment binary application object having a .CnBin file extension (Step S170). Any errors resultant during the process are logged for future evaluation and debugging (Step S172) and the development environment then provides a normal response associated with that environment, for example, a normal FRONT PAGE response (Step S164).

In accordance with the process shown in FIG. 6, the present invention advantageously allows the combination of the integrated source code with a typical development environment. The result facilitates development and minimizes the need for experienced developers to have to receive training on a new web development environment tool.

Yet another example of developing with the integrated code environment is as follows. A developer, presumably on a web client, accesses a web browser on his local machine. A URL is requested that points to the locate on the harddrive of the webserver for the web development environment. The webserver authenticates the user through standard http negotiation and, in the case of MICROSOFT IIS, checks the username and password against the SAM or in the case of APACHE on UNIX, the application server authenticates the user against /etc/passwd and /etc/shadow. If the user is authenticated successfully; in the case of WINDOWS IIS, the process begins running as that user. In the case of APACHE on UNIX, the application server changes the process using a kernel module to be running as the authenticated user.

Execution is passed to the application server to run the binary objects for the web development environment. These are a collection of joints which allow the user, web client, to create solutions. These binary objects execute and produce an interactive HTML environment for editing text files, maintaining project settings, etc. After the developer has created an application he may build it from the by choosing a ‘BUILD’ menu option in a BUILD menu. This converts rivets to source joints, compiles source joints to binary joints, links appropriate libraries, and produces the result binary file. Any errors during the process are logged and displayed to the developer through the HTML interface and binary WDE objects. The developer may then execute the application by using the ‘execute’ option in the ‘BUILD’ menu.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for a web-based application, the method comprising:
preparing integrated source code, the integrated source code including source code in a first programming language and source code in a second programming language; and
processing the integrated source code to create compilable homogenous source code in the first programming language.

2. The method of claim 1, wherein the first programming language is C++.

3. The method of claim 1, wherein the second programming language is hypertext mark-up language.

4. The method of claim 1, further comprising compiling the homogenous source code into a natively executable program.

5. The method of claim 4, further comprising storing the natively executable program on an application server.

6. The method of claim 5, further comprising executing the natively executable program if a predetermined file extension corresponding to the natively executable program is detected.

7. The method of claim 5, further comprising:
receiving a web page request;
executing an application server program;
loading the stored natively executable program;
preparing a request object;
executing the stored natively executable program and creating a response object based at least in part on the request object, the response object including response object data; and
sending a response to a web server program, the response including at least a part of the response object data.

8. The method of claim 7, wherein the web page request is an HTTP request, and wherein the response includes HTML instructions.

9. The method of claim 1, wherein the source code in the first programming language includes global source code, and wherein processing the integrated source code includes:
encapsulating the source code in the first programming language into at least one function;
encapsulating the source code in the second programming language into at least one output statement; and
integrating the global source code in the first programming language into at least one function.

10. A system for providing web data to a web client, the system comprising:
a development server, the development server having a first memory storing integrated source code, the integrated source code including source code in a first programming language and source code in a second programming language; and
a central processing unit operably coupled to the first memory, the central processing unit processing the integrated source code to create compilable homogenous source code in the first programming language.

11. The system of claim 10, wherein the source code in the first programming language is isolated from the source code in the second programming language in the integrated source code by a set of predetermined tags.

12. The system of claim 11, wherein the first programming language is C++.

13. The system of claim 12, wherein the second programming language is HTML.

14. The system of claim 1, wherein central processing unit in the development server further compiles the homogenous source code into a natively executable program.

15. The system of claim 14, wherein the development server further includes a network interface operably coupled to the first memory and the development server central processing unit, the system further including:
a communication network coupled to the development server network interface; and
an application server, the application server including:
an application server network interface couplable to the communication network and adapted to receive the natively executable program from the development server; and
a second memory operably coupled to the application server network interface, the second memory storing the natively executable program.

16. The system of claim 15, wherein the application server further includes a central processing operably coupled to the second memory and the application server network interface, the application server central processing unit executing the natively executable program if a predetermined file extension corresponding to the natively executable program is detected.

17. The system of claim 15, wherein the application server further includes a central processing operably coupled to the second memory and the application server network interface, the system further comprising:
a web server program, the web server program:
being executable to receive a web page request via the communication network; and
issuing an instruction to the application server to load the stored natively executable program;
the application server central processing unit further:
preparing a request object in accordance with the issued instruction from the web server program;
executing the stored natively executable program and creating a response object based at least in part on the request object, the response object including response object data; and
sending a response to the web server program, the response including at least a part of the response object data.

18. The system of claim 17, wherein the web page request is an HTTP request, and wherein the response includes HTML instructions.

19. The system of claim 10, wherein the source code in the first programming language includes global source code, and wherein the central processing unit processes the integrated source code to:
encapsulate the source code in the first programming language into at least one function;
encapsulate the source code in the second programming language into at least one output statement; and
integrate the global source code in the first programming language into at least one function.

20. The system according to claim 10, wherein the first memory further stores a web development environment application and wherein the development server central processing unit executes the web development environment application to allow a user to remotely access the development server to develop the integrated source code and to initiate the processing of the integrated source code into the homogeneous source code.

21. The system according to claim 14, wherein the first memory further stores a web publishing environment application and wherein the development server central processing unit executes the web publishing environment application to allow a user to remotely access the development server to develop the integrated source code, and to initiate the processing of the integrated source code into the natively executable code by issuing a publication trigger.

22. A computing device for developing a web application, the computing device comprising:
a memory, the memory storing a first source code for a program, the first source code for the program being written in a plurality of programming languages; and
a central processing unit operatively coupled to the memory, the central processing unit processing the first source code to create a second source code corresponding to the source code, the second source code being in one of the plurality of programming languages.

23. The computing device of claim 22, wherein the plurality of programming languages includes C++ and HTML.

24. The computing device of claim 22, wherein the one of the plurality of programming languages is C++.

25. The computing device of claim 22, wherein the central processing unit further compiles the second source code into a natively executable program.

26. The computing device of claim 22, wherein the first source code includes traditional programming language source code and contemporary programming language source code, the traditional programming language source code having global source code, and wherein processing the first source code includes:
encapsulating the traditional programming language source code into at least one function;
encapsulating the contemporary programming language source code into at least one output statement; and
integrating the global source code into at least one function.

27. The computing device of claim 22, wherein the source code in the one of the plurality of programming languages is isolated from the source code in the other of the plurality of programming languages a set of predetermined tags.
